(19) United States
(12) Patent Application Publication
(10) Pub. No.: US 2023/0356306 A1
(43) Pub. Date: Nov. 9, 2023

(54) RECESS TOOL FOR FLUSH-MOUNT TRIM

(71) Applicant: RABBET SAW LLC, San Clemente, CA (US)

(72) Inventor: Ryan Andrew Mateer, San Clemente, CA (US)

(21) Appl. No.: 18/141,938

(22) Filed: May 1, 2023

Related U.S. Application Data
(60) Provisional application No. 63/338,565, filed on May 5, 2022.

(51) Int. Cl. B23B 51/04

(52) U.S. Cl. CPC B23B 51/0426

(57) ABSTRACT

The present disclosure generally relates to a recess tool configured to cut a circular recess in drywall, thus enabling the flush mounting of a recessed light trim. The present disclosure generally describes a recess tool having a circular plate with cutting teeth and a guide. The recess tool is configured to be removably secured to a drill such that when operated, the cutting teeth of the circular plate rotate and cut a recess into drywall and stop once the recess reaches a predetermined depth. The guide is configured to be inserted into a can light opening, thereby creating the recess at the location of the recessed light. Once the recess tool cuts a recess into the drywall, a mud ring may be placed into the recess such that the trim is flush with the uncut drywall, thereby creating a flat surface to mud.

### CROSS-REFERENCE TO RELATED APPLICATIONS

This application claims benefit of Provisional Application No. 63/338,565 filed May 5, 2022, the entirety of which is hereby incorporated by reference in its entirety.

### TECHNICAL FIELD

The present disclosure generally relates to a recess tool for creating a flush-mount trim on a drywall for recessed lights.

### BACKGROUND

Flush mounted recessed lighting has become very popular in homes, as homeowners desire recessed lighting but wish to avoid the exposed trim that is generally required for recessed lights. When installing flush mounted recessed lighting, a mud ring is required, but the mud ring sits on top of the drywall, and is thus raised or proud from the drywall. The trim of the mud ring similarly sits proud from the drywall. To create a flush appearance on the drywall with the proud mud ring and trim, a large 5-6 foot feather mud float process is required for each light in order to blend the surface mounted mud ring with the drywall.

The mud float process generally has a number of drawbacks. For example, mudding over just the mud rings typically creates unsightly humps on the flat ceiling surface due to the extra mud float over the proud portions of the mud rings in relation to the ceiling. Previously, workers would create the large 5-6 foot mud floats to solve this issue and trick the eye into thinking the ceiling surface is flat and does not include any humps around the light fixture. However, this mud float process adds additional time and costs to the drywall stage of construction, which in turns holds up contractors or homeowners who have work after the drywall stage. This additional time and costs are typically passed on to the homeowner, adding additional fees and delay to the building or remodeling processes.

Therefore, there is a need for a system that enables recessed lighting to be mounted such that the trim is flush with the drywall that does not require the lengthy and costly mut float process described above, thereby cutting down on labor time and costs.

### SUMMARY

Disclosed herein is a recess tool that creates a recess in drywall at a predetermined depth, thereby enabling a mud ring and trim to sit flush or flat with the drywall line. The recess tool is configured to cut a recess that is of a larger diameter than the mud ring such that the mud ring fully sits inside the recess. Once the mud ring sits within the recess, the mud ring and trim will be flush with the un-recessed portions of the drywall, eliminating any humps around the light fixture when the mud float process is applied. Additionally, as the recess may only be slightly larger in diameter than the mud ring, the mud float process is significantly simplified because the mud only needs to cover from the edge of the recess to the trim. Once complete, the trim will be flush with the drywall and mud, thereby creating a flush appearance without any humps caused by the proud mud ring. The simplification of this process thus eliminates the need to perform 5-6 foot mud float processes around each light fixture, thereby drastically reducing the labor time and material costs previously required while creating a seamless, flush trim appearance in the process.

As described herein, a recess tool generally includes a circular plate having a one or more cutting teeth, and a guide. The recess tool is configured to be removably secured to a drill such that when operated, the one or more cutting teeth cut a recess into drywall. The plate generally includes three portions of concentric circles, namely, an inner portion configured to accept the guide, a middle portion having the one or more cutting teeth with a predetermined height, and an outer portion configured to prevent the plate from cutting deeper into the drywall than the predetermine height of the one or more cutting teeth. The guide is generally configured to be inserted into a can light opening, thereby guiding the plate to the correct location in relation to the placement of the recessed light fixture. Once the recess tool cuts a recess into the drywall, a mud ring may be placed into the recess such that the trim is flush with the uncut drywall line, thereby removing the mud ring hump and creating a flat surface to mud. As such, the recess tool solves the aforementioned problems with regard to mounting flush mounted recessed lighting.

### BRIEF DESCRIPTION OF THE DRAWINGS

FIG. 1 is a perspective view of a person using a recess tool.

FIG. 2 is a perspective view of a mud ring positioned in a recess of a ceiling created by the recess tool of FIG. 1.

FIG. 3 is a top perspective view of the recess tool of FIG. 1.

FIG. 4 is a side view of the recess tool of FIG. 1.

FIG. 5 is an exploded side view of the recess tool of FIG. 1.

FIG. 6 is a top view of a plate of the recess tool of FIG. 1.

FIG. 7 is a bottom view of the plate of the recess tool of FIG. 1.

FIG. 8 is a zoomed-in side view of a cutting tooth of the plate of the recess tool of FIG. 1.

FIG. 9 is a top perspective view of a recess tool in accordance with another embodiment.

FIG. 10 is a side view of a recess tool in accordance with another embodiment.

FIG. 11 is a top view of a plate of a recess tool in accordance with another embodiment.

FIG. 12 is a method of manufacturing a recess tool.

Corresponding reference characters indicate corresponding elements among the view of the drawings. The headings used in the figures do not limit the scope of the claims.

### DETAILED DESCRIPTION

### Overview

The present disclosure is directed to tools configured to cut or bore a circular recess in drywall, thus enabling the flush mounting of a recessed light trim. For example, the present disclosure describes a recess tool having a circular plate with cutting teeth and a guide. The recess tool is configured to be removably secured to a drill such that when operated, the cutting teeth of the circular plate cut a recess into drywall. The plate is configured to include one or more cutting teeth configured to tear drywall paper and remove drywall material, thereby creating a recess within the drywall. The guide is configured to be inserted into a can light opening, thereby guiding the plate to the correct location in relation to the placement of the recessed light. Once the recess tool cuts a recess into the drywall, a mud ring may be placed into the recess such that the trim is flush with the uncut drywall, thereby removing the mud ring hump and creating a flat surface to mud.

### Description

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

As used herein, the term “coupled” refers to joining two members or components directly or indirectly to one another. Such joining may be stationary in nature or movable in nature. Such joining may be achieved with the two members only or with the two members and additional intermediate members. Further, such joining may be achieved by integrally forming the two members as a single unitary body or by a physical connection between the two members. In this fashion, the joining between two members may be removable, releasable, and/or permanent in nature.

As used herein, the terms “inner,” “middle,” “outer,” “right,” “left,” and “top,” “bottom,” in this description identify relative spatial relationships between various elements as they are oriented in the figures. It is appreciated that these terms are not meant to limit the element which they describe, as the various elements may be oriented differently in different views and in different applications.

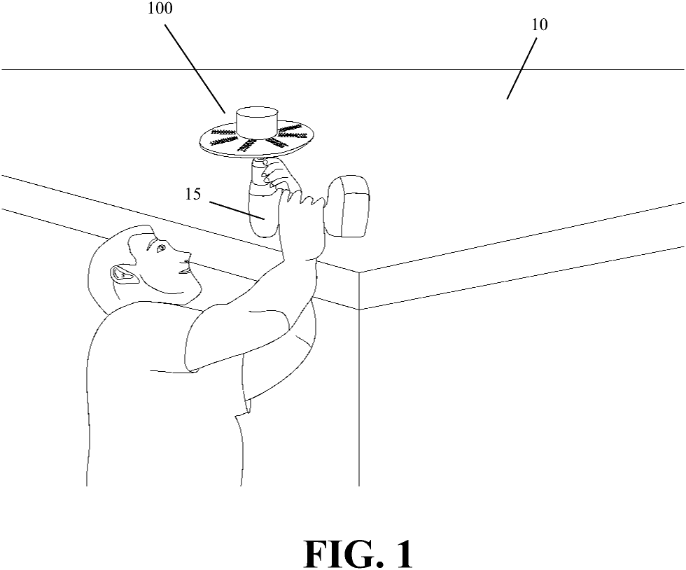

FIG. 1 depicts the general background of using a recess tool 100 in accordance with the disclosure. As shown, the recess tool 100 is configured to be removably secured to a drill 15. Once secured to the drill 15, the recess tool 100 is capable of cutting a recess into drywall 10, such as the ceiling drywall 10 depicted in FIG. 1.

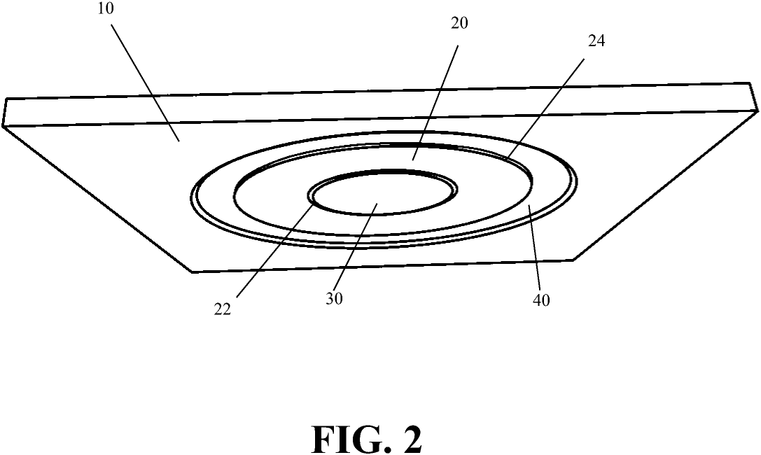

FIG. 2 depicts a mud ring 20 mounted to drywall 10 after using the recess tool 100 to bore a recess 40 in the drywall 10. Generally, the mud ring 20 includes a trim 22, an edge 24, and a can light opening 30. The can light opening 30 is configured to accept a can light, such that the can light is recessed within the drywall 10. Prior to the use of the recess tool 100 disclosed herein, mounting the mud ring 20 to the drywall 10 would result in a proud edge 24 and trim 22 of the mud ring 20 in relation to the drywall 10, thus requiring the additional mud float process described above to create a flush trim appearance.

Upon use of the recess tool 100, the recess 40 is cut into the drywall 10. In some embodiments, the recess 40 is configured to be of a depth equal or greater than the edge 24 of mud ring 20 and in some embodiments of a depth equal to the trim 22. Thus, at least the trim 22 is aligned with the uncut portion of the drywall 10, thereby creating a flat surface between the drywall 10 line and trim 22 once the mud is applied. As such, the recess 40 created by the recess tool 100 enables the trim 22 to be flush with the mud once applied to the drywall 10.

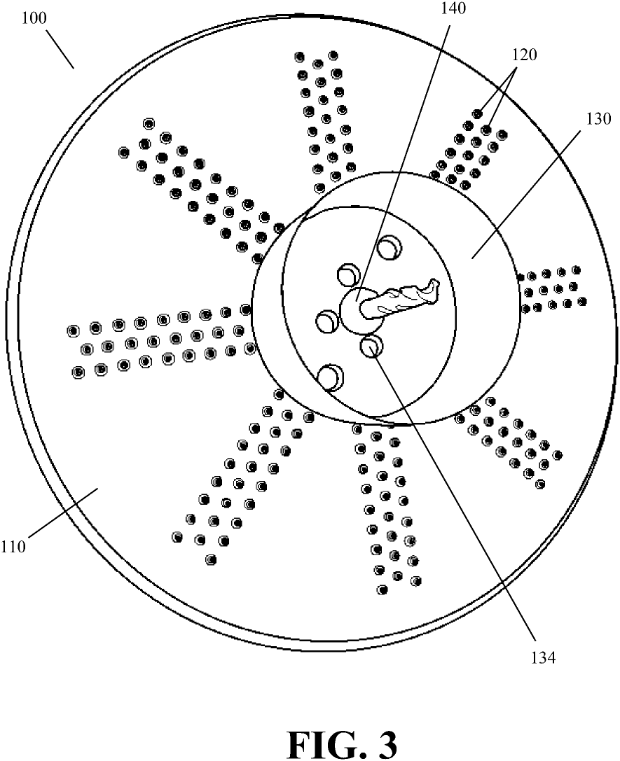

FIGS. 3-8 depict an exemplary embodiment of the recess tool 100. As shown in FIG. 3, the recess tool 100 generally includes a plate 110, one or more cutting teeth 120, and a guide 130. In this embodiment, the recess tool 100 is configured to be removably secured to the drill 15 by a hole saw mandrel 140. In other embodiments, the recess tool 100 may be removably secured to the drill 15 by any suitable means. As further described herein, the plate 110 includes the one or more cutting teeth 120 having a predetermined height and is configured to cut or bore into drywall 10 to a predetermined depth. The guide 130 is configured to be inserted into the can light opening 30 of the mud ring 20, thereby providing the recess tool 100 with a central point around which the plate 110 rotates when the drill 15 is activated. Thus, the guide 130 effectively guides the plate 110 to the correct location on the drywall 10 in relation to the light fixture.

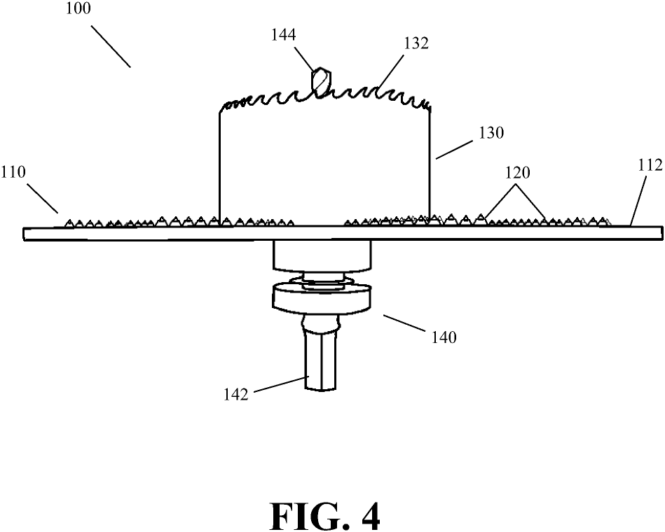

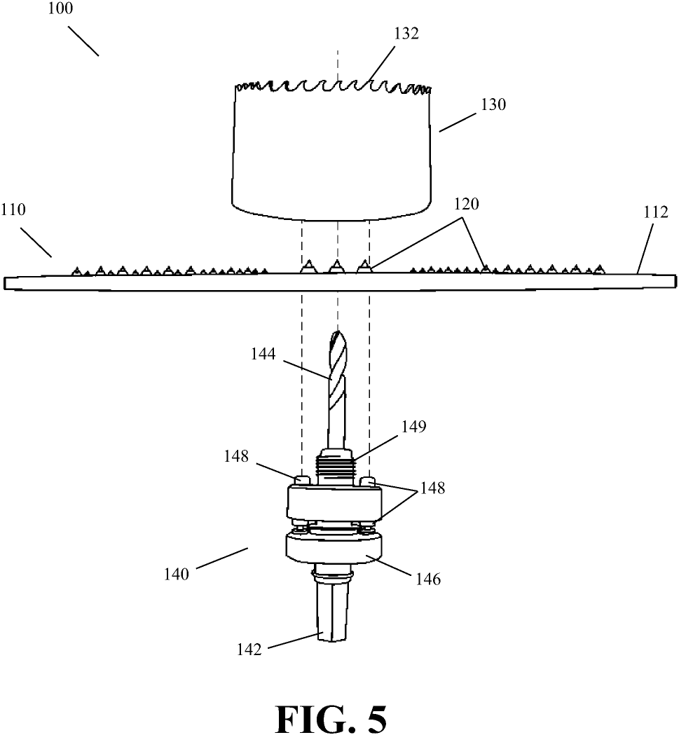

In the exemplary embodiment depicted in FIGS. 3-8, the plate 110, guide 130, and hole saw mandrel 140 are configured to be separate components that are coupled together as depicted in FIGS. 4-5, while the plate 110 and one or more cutting teeth 120 are formed as a unitary structure. However, in some other embodiments, the one or more cutting teeth 120 may be formed separate from the plate 110 and coupled thereafter. In other embodiments, the plate 110, one or more cutting teeth 120, guide 130, and hole saw mandrel 140 are configured to be formed as a single unit, for example by injection molding. In other embodiments, the plate 110, one or more cutting teeth 120, and guide 130 are configured to be a single unit, with a separate hole saw mandrel 140. It is thus contemplated that each individual component described may be formed as a single unit or formed individually and coupled or removably coupled together thereafter. It is also contemplated that some but not all of the individual components may be formed together as unitary components then coupled to the other components thereafter.

FIGS. 4 and 5 depict a side view of the recess tool 100 coupled together (FIG. 4) or decoupled as individual components (FIG. 5). In the exemplary embodiment, the recess tool 100 is removably secured to the drill 15 by a hole saw mandrel 140. The hole saw mandrel 140 in the exemplary embodiment generally includes a shaft 142 for insertion into the drill 15, a drill bit 144, a rotating member 146, one or more pins 148, and a threaded member 149. The rotating member 146 is configured to drive the one or more pins 148 upward or downward depending on the directional rotation of the rotating member 146. While the hole saw mandrel 140 is described in the context of the exemplary embodiment, it is appreciated that any standard hole saw mandrel, mandrel, arbor, or suitable means for securing the recess tool 100 to the drill 15 may be utilized without departing from the concepts disclosed herein. Furthermore, other embodiments may use different configurations depending on whether the hole saw mandrel 140 is manufactured as a separate structure or as a single unit with the other components. For example, in embodiments where the plate 110, one or more cutting teeth 120, and guide 130 are a single unit, the shaft 142 may be formed with the plate 110 and guide 130 such that the hole saw mandrel 140 is not required for securing the single unit recess tool to the drill. Thus, the specific configuration of the hole saw mandrel 140 may vary without departing from the concepts disclosed herein.

As described above, the guide 130 is configured to be inserted into the can light opening 30 of the mud ring 20. In the exemplary embodiment depicted in FIG. 3, the guide 130 includes one or more pin apertures 134 configured to accept the one or more pins 148 of the hole saw mandrel 140 and a mandrel aperture configured to accept the threaded member 149 of the hole saw mandrel 140. The mandrel aperture may be threaded such that the threaded member 149 of the hole saw mandrel 140 may be threaded into the guide 130. Thus, when the hole saw mandrel 140 is coupled to the plate 110 and guide 130 as shown in FIG. 5, the drill bit 144 and threaded member 149 will pass through the mandrel aperture of the guide 130 and the one or more pins 148 will align with the one or more pin apertures 134. Thus, when the one or more pins 148 are driven upward by the rotating member 146, the one or more pins 148 are inserted into the one or more pin apertures 134.

The guide 130 may be configured to include a flat top surface for simply guiding the recess tool 100 to the can light opening 30, as shown in FIG. 3, or alternatively, may be configured similar to a hole saw such that the guide 130 includes a plurality of guide teeth 132, as shown in FIGS. 4 and 5. In some other embodiments, the guide 130 may be a hole saw. In embodiments using a flat top surface, the recess tool 100 will be configured to be inserted into a previously cut can light opening 30 to guide the recess tool 100 to the proper position on the drywall 10. However, in embodiments having a plurality of guide teeth 132, the guide 130 may also act as a cutting member to cut through the drywall 10, thereby creating the can light opening 30 at the same time as boring the recess 40.

The guide 130 may be constructed out of any suitable material and may be of any size suitable to fit within a can light opening 30 or create a can light opening 30. For example, can sizes generally range from a 1-inch diameter to a 7-inch diameter, but can be smaller or larger depending on the light fixture. The guide 130 should be of a size that matches the respective can light size sought. Additionally, the guide 130 may generally be constructed out of any suitable materials, including but not limited to metals (anodized or non-anodized), plastics, resins, woods, carbides, or similar materials, and may be formed with the same or different materials than the other components.

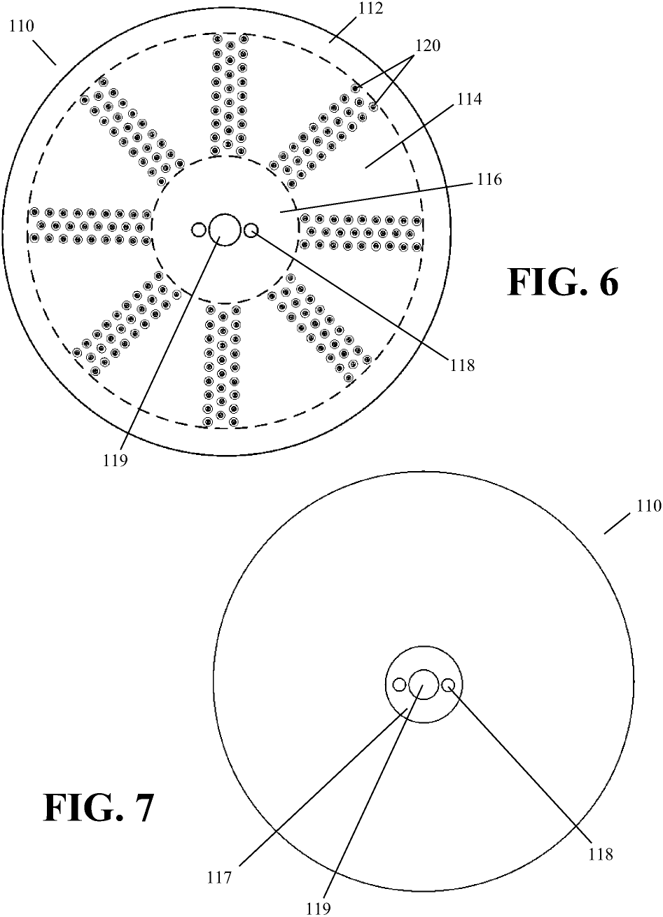

FIGS. 3-8 depict the exemplary embodiment of the plate 110. As shown, the plate 110 is preferably circular in shape and configured to cut the circular recess 40 in the drywall 10. As shown in this embodiment, the plate 110 includes one or more cutting teeth 120. Furthermore, as depicted in FIG. 6, the plate 110 is configured to include three portions, namely an outer portion 112, a middle portion 114, and an inner portion 116, each with its own unique purpose as further discussed below. Additionally, the three portions each may form concentric circles with each other, such that the outer portion 112 encircles the middle portion 114 and inner portion 116, and the middle portion 114 encircles the inner portion. The plate 110 also includes one or more pin apertures 118 and a mandrel aperture 119, as well as a mandrel recess 117 on the bottom portion of the plate 110, as shown in FIG. 7. Similar to the guide 130, the one or more pin apertures 118 are configured to accept the one or more pins 148 of the hole saw mandrel 140 and the mandrel aperture 119 is configured such that the threaded member 149 of the hole saw mandrel 140 may pass through the mandrel aperture 119. In some embodiments, the mandrel aperture 119 may be threaded such that the plate 110 may be secured onto the threaded member 149 of the hole saw mandrel 140. In other embodiments, the mandrel aperture 119 is unthreaded, allowing the hole saw mandrel 140 to be freely inserted through the mandrel aperture 119. In these embodiments, the mandrel recess 117 and one or more pin apertures 118 secure the plate 110 to the hole saw mandrel 140 such that the plate 110 rotates with the hole saw mandrel 140 when the drill 15 is activated. In other embodiments, the plate 110 may not require the mandrel aperture 119 or one or more pin apertures 118, such as embodiments having the plate 110, guide 130, and shaft 142 formed as a unitary structure. Additionally, the plate 110 may generally be constructed out of any suitable material, including but not limited to metals (anodized or non-anodized), plastics, resins, woods, carbides, or similar materials, and may be formed with the same or different materials than the other components.

FIG. 6 depicts the three unique portions of the plate 110. First, the inner portion 116 is configured to include the one or more pin apertures 118, the mandrel aperture 119, and the mandrel recess 117 on the bottom of the plate 110. Additionally, the inner portion 116 is configured to have the same diameter as the guide 130, such that the guide 130 sits level on the plate 110 and is immediately proximate to the middle portion 114 having the one or more cutting teeth 120. It is appreciated that diameter of the inner portion 116 of the plate 110 may vary in accordance with the diameter of the guide 130. In some embodiments, the guide 130 is configured to be positioned within the inner portion 116 of the plate 110 and coupled to the plate 110 by the hole saw mandrel 140. In other embodiments, the guide 130 is configured to be coupled with the inner portion 116 of the plate 110 during manufacture. It is appreciated that the guide 130 may be coupled to the inner portion 116 of the plate 110 through a variety of other attachment or coupling mechanisms as well, such as adhesives or other threaded attachments.

Next, the middle portion 114 is configured to include the one or more cutting teeth 120, thereby providing the plate 110 with the ability to bore into the drywall 10 and create the recess 40. In the exemplary embodiment depicted by FIGS. 3-8, the middle portion 114 includes the one or more cutting teeth 120 in a spoke pattern, with eight sets of cutting teeth 120 having three rows of individual cutting teeth spanning the distance between the inner portion 116 and the outer portion 112. Once secured to the drill 15 and activated, this pattern permits the one or more cutting teeth 120 to tear into the drywall 10 while the plate 110 rotates about the hole saw mandrel 140, while providing a gap between each set of cutting teeth 120 to collect the drywall material removed from the drywall 10. In other embodiments, other patterns of the one or more cutting teeth 120 may be utilized without departing from the concepts disclosed herein. For example, less or more than eight sets of cutting teeth 120 having more or less than three rows may be used, or alternatively the one or more cutting teeth 120 may cover the entirety of the middle portion 114.

The diameter of the middle portion 114 of the plate 110 may vary between embodiments, but the middle portion 114 must have a diameter larger than the mud ring 20 that is configured to be placed in the recess 40. In the exemplary embodiment shown, the middle portion 114 is slightly larger in diameter than the mud ring 20, such that the entirety of the mud ring 20 fits within the recess 40 bored by the one or more cutting teeth 120. While the overall size of the plate 110 may vary between embodiments, the combined diameter of the middle portion 114 and inner portion 116 must be greater than the diameter of the mud ring 20.

The one or more cutting teeth 120 of the plate 110 are configured to have a predetermined height configured to set a predetermined depth of the recess 40 when bored out of the drywall 10. In the exemplary embodiment, the predetermined height of the one or more cutting teeth 120 match the height of the trim 22 extending out of the drywall 10, thereby boring into the drywall 10 to the predetermined depth. Importantly, the cutting teeth 120 do not bore beyond the predetermined depth due to the outer portion 112 of the plate 110, which is configured to stop the recess tool 100 from cutting or boring into the drywall 10 deeper than the predetermined height of the one or more cutting teeth 120. The outer portion 112 is a flat or substantially flat surface of the plate 110 and does not include any cutting teeth or textured elements that could potentially cut into the drywall 10. Thus, when used, the one or more cutting teeth 120 tear into the drywall 10 until the outer portion 112 of the plate 110 contacts the drywall 10, thereby preventing the plate 110 from tearing any deeper into the drywall 10. This in turn creates the predetermined depth for the mud ring 20 and trim 22 to be flush with the uncut drywall line. While the heights of the one or more cutting teeth 120 may vary from embodiment to embodiment, the predetermined height of the one or more cutting teeth 120 should be sufficient for the trim 22 of the mud ring 20 to be flush with the uncut portions of the drywall 10.

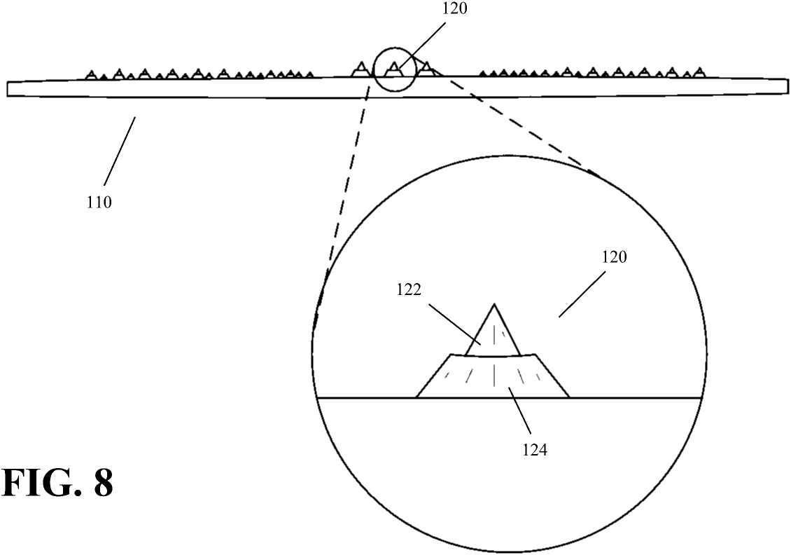

FIG. 8 depicts a zoomed-in view of one of the one or more cutting teeth 120 as used in the exemplary embodiment. In this embodiment, the one or more cutting teeth 120 have a two-tiered shape having a tip 122 and a base 124. The tip 122 and base 124 each have their own cone-shape, with the base 124 having a larger cone-shape than the tip 122. The two-tiered shape allows the cutting teeth 120 to tear into drywall 10, thereby permitting the recess tool 100 to bore into the drywall 10. The very sharp tip 122 is configured to tear into the drywall paper that overlays the softer drywall material, while the wider cone base 124 is configured to remove the softer drywall material once the drywall 10 is torn into by the tip 122.

While the one or more cutting teeth 120 described in the exemplary embodiment may be utilized, it is appreciated that other shapes, sizes, and types of cutting teeth 120 may be utilized for specific functions without departing from the concepts disclosed herein. For example, in some embodiments, the one or more cutting teeth 120 may be shaped as a cone, pyramid, may be shaped similar to a needle or a screw, or may be serrated. In other embodiments, the one or more cutting teeth 120 may be a blade spanning the middle portion 114 of the plate 110 such that when rotated, the blade cuts into the drywall 10 to the predetermined depth set by the predetermined height of the one or more cutting teeth 120. Thus, various configurations of the one or more cutting teeth 120 may be utilized without departing from the concepts disclosed herein.

In the exemplary embodiment depicted in FIGS. 3-8, the one or more cutting teeth 120 are formed as a unitary structure with the plate 110 itself. However, the one or more cutting teeth 120 may also be formed separate from the plate 110 and configured to be removably secured to the plate 110. For example, in some other embodiments, the plate 110 may include a plurality of threaded apertures in the middle portion 114 and the one or more cutting teeth 120 may include an additional threaded base such that the one or more cutting teeth 120 may be removed and replaced if required. In other embodiments, the one or more cutting teeth 120 may snap in and out of the plate 110, or may be adhered to the plate 110. It is appreciated that many mechanisms for securing the one or more cutting teeth 120 to the plate 110 may be utilized without departing from the concepts disclosed herein.

Once the recess tool 100 is secured to the drill 15, the rotation of the drill 15 will cause the plate 110 to rapidly rotate, and once guided into the can light opening 30 by the guide 130, the rapidly rotating one or more cutting teeth 120 will bore into drywall 10 until the outer portion 112 of the plate 110 contacts the drywall. Once the outer portion 112 contacts the drywall 10, the one or more cutting teeth 120 are prevented from boring any deeper into the drywall 10, even if the drill 15 continues to be activated and the plate 110 continues to rotate. As such, the recess tool 100 forms the uniform circular recess 40 around the can hole opening 30 for the mud ring 20 to be placed, thereby resulting in a flush trim 22 of the mud ring 20 with the uncut portion of the drywall 10.

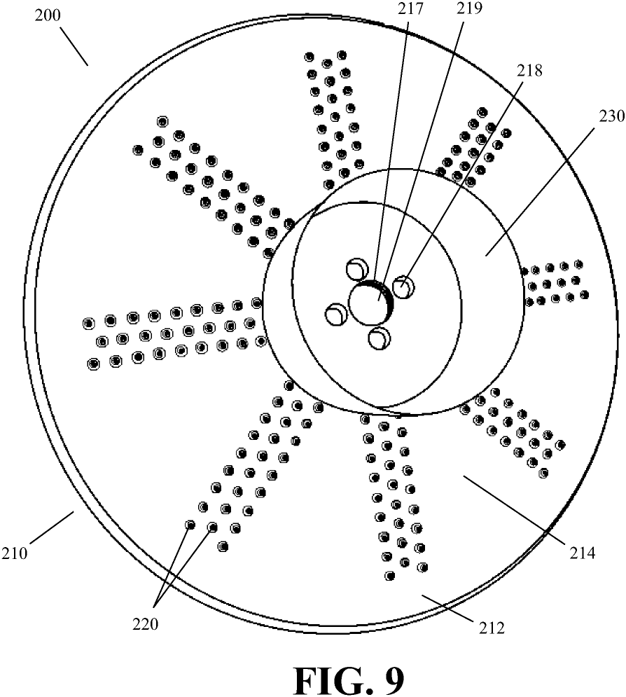

FIG. 9 depicts an alternative embodiment of the recess tool 200. In this alternative embodiment, the recess tool 200 is unitary structure having a plate 210, one or more cutting teeth 220, and a guide 230. In this alternative embodiment, these components are formed as a single unit, for example by injection mold. As shown, the guide 230 is formed at an inner portion of the plate 210, and is directly proximate a middle portion 214 of the plate 210 having the one or more cutting teeth 220. The recess tool 200 also includes an outer portion 212 configured to stop the recess tool 200 from boring into the drywall 10 deeper than the predetermined height of the one or more cutting teeth 220. Additionally, the uniform plate 210 and guide 230 have one or more pin apertures 218 and an aperture 219 having a threaded portion 217. Similar to the exemplary embodiment discussed above, the threaded portion 217 of the mandrel aperture 219 is configured to be threaded onto a standard hole saw mandrel 140 and the one or more pins 148 of the hole saw mandrel 140 are configured to be inserted into the one or more pin apertures 218, thereby removably securing the unitary recess tool 200 to the hole saw mandrel 140.

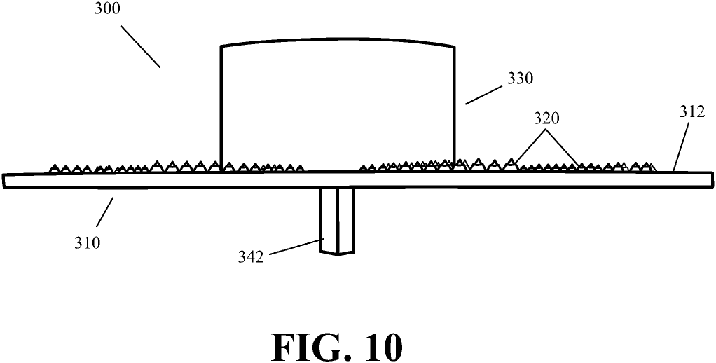

FIG. 10 depicts another alternative embodiment of the recess tool 300. In this alternative embodiment, and similar to the alternative embodiment discussed in FIG. 9, the recess tool 300 is a unitary structure having a plate 310, one or more cutting teeth 320, and a guide 330 formed as a single, unitary structure. However, this alternative embodiment also includes a shaft 342 that is formed with the recess tool 300 such that the plate 310, one or more cutting teeth 320, guide 330, and shaft 342 form a single unit. In this alternative embodiment, the shaft 342 is configured to be inserted into the drill 15 such that when the drill 15 is activated, the one or more cutting teeth 320 of the plate 310 bore into the drywall 10 until the outer portion 312 of the plate 310 contacts the drywall, thereby stopping the one or more cutting teeth 320 from boring deeper than their predetermined heights.

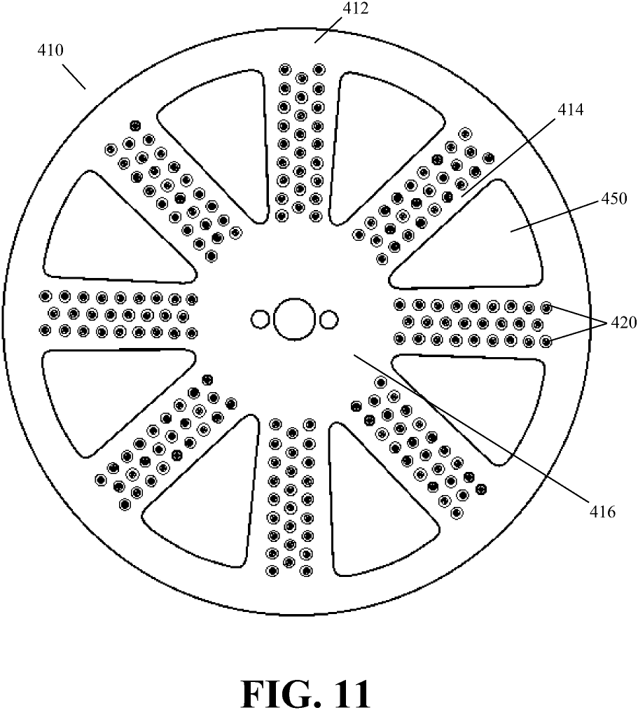

Further, an alternative embodiment of plate 410 is depicted in FIG. 11. The general structure of plate 410 is similar to the exemplary embodiment described above, as plate 410 includes an inner portion 416, a middle portion 414 having one or more cutting teeth 420 in an eight-spoke pattern, and an outer portion 412 configured to stop the plate 410 at a predetermined depth. However, the middle portion 414 of plate 410 further includes at least one cavity 450 located between the spokes of the one or more cutting teeth 420 pattern. In this alternative exemplary embodiment, the plate 410 includes the cavity 450 positioned between each of the eight spokes of the one or more cutting teeth 420, and thus include eight cavities 450 in total. The cavities 450 are configured to be recessed in the plate 410, and are configured to allow drywall material and/or dust to be collected by the plate 410. In other embodiments, openings may be created instead of the cavity 450, thereby permitting the drywall material and/or dust to fall through the openings. In these embodiments, the recess tool 100 may also include a dust catcher positioned around the drill 15 to catch or vacuum up any drywall material and/or dust falling through the openings.

While there have been shown and described illustrative examples of the recess tool, it is understood that various other adaptations and modifications may be made within the spirit and scope of the disclosure herein. For example, in embodiments employing individual components for the plate 110, one or more cutting teeth 120, and guide 130, it is contemplated that the recess tool 100 may be variable in size. To illustrate, the inner portion 116 of the plate 110 may be varied in diameter such that different sized guides 130 for different sized can light openings 30 can be used with the same plate 110 having removable cutting teeth 120, as described above. In these embodiments, removing cutting teeth 120 from the middle portion 114 of the plate proximate the inner portion 116 would effectively increase the diameter of the inner portion 116, thereby permitting a guide 130 having a larger diameter to be placed onto the plate 110. Additionally, adding cutting teeth 120 to the inner portion 116 of the plate 110 proximate the middle portion 114 would effectively reduce the diameter of the inner portion 116, thereby permitting a guide 130 having a smaller diameter to be placed onto the plate 110. As another example, different sized plates 110 having different sized cutting teeth 120 with differing predetermined heights may be utilized to provide different predetermined depths of the recess 40, thereby permitting larger or smaller mud rings 20 to be placed in the recess 40. It is appreciated that these and other modifications and variations may be made to the described embodiments without departing from the concepts disclosed herein.

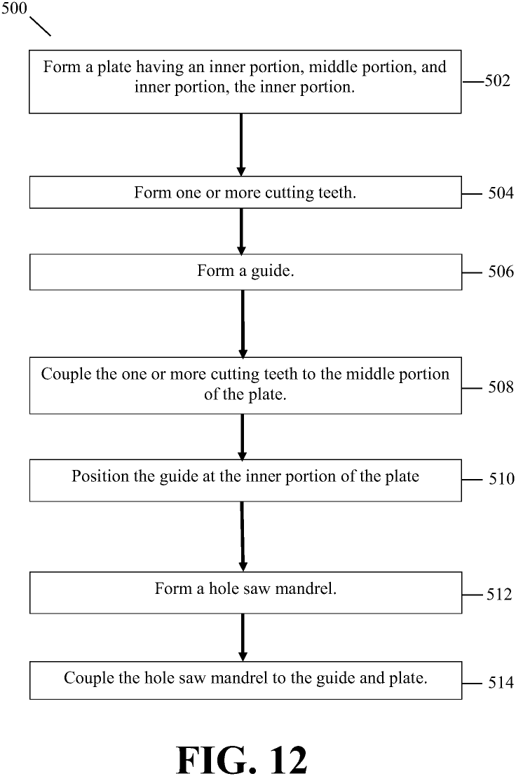

FIG. 12 depicts a method 500 of manufacturing a recess tool. It is appreciated that the general method 500 disclosed herein could be applied to any embodiment disclosed herein, as well as any other apparent variations and modifications. Additionally, the method 500 may be performed in any order, and may be done as a sequence of steps or as a single step to form a unitary structure.

As shown in FIG. 12, the first step 502, the method includes forming a plate. The plate may include an inner portion, middle portion, and an inner portion. The inner portion may include a mandrel aperture and at least one pin aperture. The second step 504 includes forming one or more cutting teeth. The one or more cutting teeth may be formed as a two-tiered cone design having a larger cone base and a smaller, pointed cone tip. The one or more cutting teeth may be formed separate from the plate or may be formed during the same process. The third step 506 includes forming a guide. The guide may include a mandrel aperture and at least one pin aperture. The guide may also include a plurality of guide teeth which may be formed during the same process. The guide may also be formed at the same time as the plate and cutting teeth, or may be formed as a separate component. The fourth step 508 includes coupling the one or more cutting teeth to the plate. The one or more cutting teeth are preferably coupled to the middle portion of the plate. The one or more cutting teeth may be coupled to the plate during formation of the plate, or may formed individually and coupled thereafter. The one or more cutting teeth may be permanently coupled to the plate or may be removably coupled to the plate. The fifth step 510 includes positioning the guide with the plate. The guide may be positioned at the inner portion of the plate such that the mandrel aperture and at least one pin aperture of the guide align with the mandrel aperture and at least one pin aperture of the plate. Positioning the guide with the plate may occur during formation of the guide and plate, in which case the guide is coupled directly to the plate. Alternatively, the guide may be coupled to the plate as a separate step if formed separately. The sixth step 512 includes forming a hole saw mandrel having at least one pin. The seventh step 514 includes coupling the hole saw mandrel to the guide and the plate. Coupling the hole saw mandrel to the guide and the plate may be accomplished by inserting the hole saw mandrel through the aligned mandrel apertures and inserting the at least one pin of the hole saw mandrel through the aligned pin apertures. It is appreciated that alternative embodiments may use some but not all of these steps, or may performed multiple of the steps in one. For example, it is contemplated that a plate, one or more cutting teeth, a guide, and a shaft may all be formed in a single step, for example by injection mold.

Thus, while the foregoing description has been directed to specific embodiments, it will be apparent that other variations and modifications may be made to the described embodiments, with the attainment of some or all of their advantages. Further, the terms “example” or “exemplary” as used throughout this disclosure indicate an example or instance and does not imply or require any preference for the noted example or otherwise limit the scope of the embodiments herein. Therefore, it is the object of the appended claims to cover all such variations and modifications as come within the true spirit and scope of the embodiments herein.

What is claimed is:

1. A recess tool comprising:
a plate having one or more cutting teeth with a predetermined height;
a guide coupled to the plate; and
a mandrel coupled to the plate and the guide;
wherein the plate is configured to cut a recess into drywall to a predetermined depth based on the predetermined height of the one or more cutting teeth.

2. The recess tool of claim 1, wherein the plate further includes an outer portion positioned around the one or more cutting teeth, the outer portion configured to prevent the plate from cutting the recess beyond the predetermined depth.

3. The recess tool of claim 1, wherein the guide is a hole saw and the mandrel is a hole saw mandrel.

4. The recess tool of claim 1, the plate further comprising an inner portion, a middle portion, and an outer portion, wherein the guide is coupled to the plate at the inner portion, the one or more cutting teeth are positioned in the middle portion, and the outer portion encircles the middle portion and the inner portion.

5. The recess tool of claim 4, wherein the inner portion, middle portion, and outer portion form concentric circles.

6. The recess tool of claim 1, wherein each of the one or more cutting teeth form a two-tiered cone shape.

7. The recess tool of claim 1, wherein the one or more cutting teeth form a spoke pattern.

8. The recess tool of claim 1, wherein the plate and the guide form a unitary structure.

9. The recess tool of claim 1, wherein the plate, the guide, and the mandrel form a unitary structure.

10. A recess tool comprising:
a plate having an inner portion, a middle portion, and an outer portion; and
one or more cutting teeth positioned at the middle portion of the plate;
wherein the one or more cutting teeth are configured to bore into drywall until the outer portion of the plate contacts the drywall.

11. The recess tool of claim 10, wherein the one or more cutting teeth are removably coupled to the plate.

12. The recess tool of claim 10, wherein the one or more cutting teeth form a spoke pattern within the middle portion of the plate.

13. The recess tool of claim 12, further comprising at least one cavity positioned in the middle portion of the plate between each spoke pattern of the one or more cutting teeth.

14. The recess tool of claim 10, further comprising a guide, wherein the guide is coupled to the inner portion of the plate.

15. The recess tool of claim 14, wherein the plate, the guide, and the one or more cutting teeth are a unitary structure.

16. The recess tool of claim 14, wherein the one or more cutting teeth are immediately proximate the guide.

17. The recess tool of claim 10, wherein each of the one or more cutting teeth form a two-tiered cone shape.

18. A method of manufacturing a recess tool comprising:
forming a plate having an inner portion, a middle portion, and an outer portion;
forming one or more cutting teeth; and
coupling the one or more cutting teeth to the middle portion of the plate.

19. The method of claim 18, further comprising:
forming a guide;
positioning the guide at the inner portion of the plate; and
coupling the guide to the plate.

20. The method of claim 19, further comprising:
forming a mandrel; and
coupling the mandrel to the guide and the plate.
